(19) United States
(12) Patent Application Publication
(10) Pub. No.: US 2025/0225885 A2
(43) Pub. Date: Jul. 10, 2025

(54) LEARNING SYSTEM AND METHOD

(71) Applicant: Anthony Nath,, London (GB)

(72) Inventor: Anthony Nath, London (GB)

(73) Assignee: Anthony Nath,, London, GL (GB)

(21) Appl. No.: 18/552,763

(22) PCT Filed: Mar. 30, 2022
(86) PCT No.: PCT/GB2022/050781

§ 371 Date: Sep. 27, 2023

(51) Int. Cl. G09B 5/06; G06F 3/01

(52) U.S. Cl. CPC G09B 5/06; G06F 3/014

(57) ABSTRACT

A method of teaching a student a skill using a learning system, the learning system having a smart speaker equipped with a microphone for listening to vocal responses and instructions issued by the student, a pair of hand peripheral devices each having an array of actuators corresponding to each of the student's fingers wherein the actuators are configured to provide haptic feedback pulses to the student, the method including providing a vocal instruction that prompts the student to look at their hands and to wait for a haptic feedback pulse, providing a visual instruction stimulus to the student, wherein the visual instruction stimulus corresponds to one of the student's fingers, providing the haptic feedback pulse(s) to said finger, and providing a trigger stimulus to the student to notify the student that a response should be input to the learning system. Inputting the response to the learning system comprises simultaneously vocalising a letter and flexing the finger that received the haptic feedback pulse.

### RELATED APPLICATIONS

This application is a national phase application of and claims priority under 35 U.S.C. § 371 of PCT Patent Application Serial No. PCT/GB2022/050781 filed on Mar. 30, 2022 and titled LEARNING SYSTEM AND METHOD. The content of this application is incorporated herein by reference.

### FIELD OF THE INVENTION

The present disclosure relates to a learning system and in particular, but not exclusively, to a learning system for teaching students to spell. Aspects of the invention relate to a learning system, to a pair of hand peripheral devices for use with the learning system, to a pair of gloves for use with the learning system and to a method of teaching a student using the learning system.

### BACKGROUND OF THE INVENTION

Humans are sentient beings that make sense of the world using the body's various sensory systems. Stimulating the body's various sensory systems is beneficial as it often leaves a person feeling engaged and curious about the experiences detected by the sensory systems. Teacher-led instruction within educational institutions and distance learning, typically limits the learning experience to one that stimulates the visual and auditory sensory systems. For many, this traditional method of teaching is ineffective and the areas of the brain that control movement and sense of touch are left underutilised, as a result the student is left disengaged.

Procedural memory or implicit memory is a form of memory which results from direct experience. It is responsible for the development of habits, behaviours and skills, for instance playing a learned piano piece without a music manuscript or, riding a bicycle and even tying one's shoelaces. Through repetition and practice, these memories can be recalled without our conscious recollection. Procedural memories are encoded and stored in several regions of the brain, namely: the cerebellum, motor cortex (M1) and the striatum which comprises the caudate nucleus and putamen, refer to FIG. 10 and FIG. 11.

Harnessing the brains capacity for neuroplasticity and procedural memory may be used as an effective way of teaching students' new skills and behaviours. There is therefore a need to develop a novel learning system that is more engaging and enhances the learning experience by activating parts of the brain to a greater degree than is typically achieved using conventional teaching methods, for example by activating the student's procedural memory.

### SUMMARY OF THE INVENTION

According to an aspect of the present invention there is provided a method of teaching a student a skill using a learning system, the learning system comprising a smart speaker equipped with a microphone for listening to vocal responses and instructions issued by the student; a pair of hand peripheral devices each having an array of actuators corresponding to each of the student's fingers wherein, the actuators are configured to provide a haptic feedback pulse(s) to the student, the method comprising: providing a vocal instruction that instructs the student to place their hands on the peripheral devices; prompt the student to look out for the finger that is to be pointed at and count the number of taps; prompt the student to focus their gaze on a single finger using an instruction stimulus that is visual; providing a haptic feedback pulse(s) to said finger; and providing a trigger stimulus to the student to notify the student that a response should be input into the learning system; wherein inputting the response to the learning system comprises simultaneously vocalising a letter, and flexing the finger that received the haptic feedback.

The method beneficially causes repeated coactivation of the student's visual, sensory, and motor systems to elicit neuroplastic change, ultimately achieved through the development of a new skill. The method beneficially causes learning to become a multi-sensory experience and memories become more multifaceted, which may provide alternative pathways for a memory or particular facet(s) of a memory, to be retrieved.

In one embodiment flexing the finger that received the haptic feedback may comprise depressing the actuator corresponding to said finger. The actuator may be a button comprising a haptic feedback actuator. The button may be a button within an array of buttons positioned on a hand peripheral device.

In another embodiment providing the visual stimulus may comprise drawing the student's attention to the finger before said finger is provided with haptic feedback. Drawing the students' attention to the finger may comprise displaying an arrow on a display to attract the students gaze or through providing an audible cue to the student.

In an embodiment the method may comprise determining a letter that is to be input as the response which is dependent on the received visual stimulus and haptic feedback. The student may determine the letter based on the number of haptic feedback pulses provided to the finger.

In one embodiment providing the trigger stimulus may comprise displaying an alphabet on a display.

In another embodiment providing the trigger stimulus may comprise providing an audible cue to the student.

In an embodiment inputting the response causes the letter to be displayed on a visual display unit. The method may further comprise comparing the vocalised letter with a correct letter for spelling a word, and displaying the letter on the display when it is determined that the vocalised letter matches the correct letter.

Displaying the letter on the visual display unit may further comprise displaying the letter within a segmented word that the student is learning to spell. The segmentation of words may be reliant on the student's spelling ability. Furthermore, the method may comprise displaying illustrations to the student and those illustrations may be indicative of the word that is to be spelled.

In a further embodiment the method may comprise varying the number of haptic feedback pulses provided depending on the letter to be vocalised.

According to a further aspect of the present invention there is provided a learning system for teaching a student a learning outcome, the learning system comprising: a pair of hand peripheral devices each having an array of actuators corresponding to each of the student's fingers wherein each actuator is configured to provide a haptic feedback pulse to a corresponding finger wherein the haptic feedback pulse is indicative of the learning outcome; a microphone configured to detect speech indicative of the learning outcome vocalised by the student; and a control module connected to the pair of hand peripheral devices; wherein the control module is configured to output a signal to the actuators to provide haptic feedback pulses to the corresponding finger; and the control module is further configured to determine that the learning outcome has been satisfied in dependence on the student simultaneously pressing the actuator that provided the haptic feedback pulses and vocalising the learning outcome.

The learning outcome may be a word that the student is learning to spell. The control module may be configured to determine when a student has correctly vocalised a letter of the word and simultaneously pressed an actuator that corresponds to the letter. The process may be repeated multiple times until the word has been completed and the learning outcome has been fully satisfied by vocalising each letter in the word whilst simultaneously pressing the actuator that corresponds to the letter.

In one embodiment the hand peripheral devices may each comprise a display for displaying information to the student. In another embodiment the control module may be configured to activate the display to display a visual instruction stimulus to the student prior to providing the haptic feedback pulse. The control module may be configured to activate the display such that visual instruction stimulus is displayed on the display at a position that corresponds to the finger that will receive the haptic feedback pulse. For example, the visual instruction stimulus may be an arrow directed to the finger that is about to receive the haptic feedback pulse.

In one embodiment the control module may be further configured to activate the display to display a trigger stimulus to the student after providing the haptic feedback pulse. For example, the trigger stimulus may be an alphabet displayed to the student on the display.

In another embodiment the learning system may comprise a speaker for outputting a vocal instruction to prompt the student to look at their hands. The control module may be configured to cause the speaker to output the vocal instruction prior to providing haptic feedback to the corresponding finger.

In one embodiment the trigger stimulus may further comprise a verbal or audible cue output from the speaker. The verbal cue may be output from the speaker at the same time as the alphabet is displayed on the display.

In an embodiment the learning system may comprise a visual display unit. The visual display unit may be configured to display the learning outcome to the student when the control module determines that the learning outcome has been satisfied. The learning outcome may be a letter of a word that the student is learning to spell.

### BRIEF DESCRIPTION OF THE DRAWINGS

One or more embodiments of the invention will now be described, by way of example only, with reference to the accompanying drawings, in which:

FIG. 1 is a schematic diagram of a learning system according to an embodiment of the invention;

FIG. 2 is a schematic plan view of a hand peripheral device for use with the learning system of FIG. 1;

FIG. 3 is a schematic side view of the hand peripheral device of FIG. 2;

FIG. 4 is a schematic view of a pair of hand peripheral devices and the student's hands;

FIG. 5 is a flow chart showing method steps of teaching a student using the learning system;

FIG. 6 is a schematic plan view of a hand peripheral device with an instruction stimulus shown on a display of the device;

FIG. 7 is a schematic plan view of a hand peripheral device with a portion of the alphabet shown on the display of the device;

FIG. 8 is a schematic image of an oligodendrocyte attached to an axon between two neurons in a brain;

FIG. 9 is a schematic image of a glove suitable for use with embodiments of the invention;

FIG. 10 is a schematic sectional view of a human brain; and

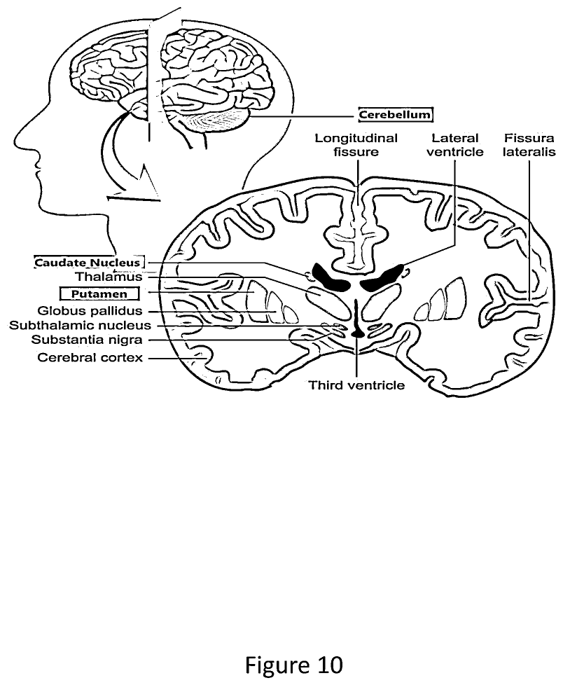

FIG. 11 is schematic side view of a human brain.

### DETAILED DESCRIPTION OF THE INVENTION

In general terms, embodiments of the invention relate to a learning system for teaching students' new skills, for example to teach students how to spell; learn a new language or to develop numeracy skills. The learning system comprises a pair of hand peripheral devices each having an array of buttons corresponding to each of the student's fingers, such that the student may rest the tips of their fingers on each button. Each button may comprise an actuator for providing haptic feedback to the student via their fingertips. The learning system further comprises a visual display unit for displaying a learning exercise, for example a word to be spelt. The learning system also comprises a smart speaker and a microphone for listening to words or sounds the student vocalises in response to a stimulus from one or more of the hand peripherals, the visual display unit, or the speaker.

The learning system beneficially provides an improved method of learning new skills and for storing the new skill in the students' procedural memory. Haptic feedback may be provided to the student via the buttons in the hand peripheral device, prior to spelling a new word. The haptic feedback may correspond to letters associated with each button on the array of buttons and in particular, the order in which the student should press the buttons to correctly spell the word. Once the student has received the haptic feedback, they must press each button correctly in order whilst simultaneously vocalising the letter that they are inputting to spell the word.

This is beneficial as the method of teaching the student to spell new words not only activates the student's visual and auditory sensory systems but also, the student's sense of touch (in response to the haptic feedback) and fine motor skills (when the student is required to correctly push each button on the peripheral device). By activating multiple sensory systems, the student may harness the brain's capacity for neuroplasticity and the new skill, in this instance how to spell a word, will be stored and retrieved from the student's procedural memory system.

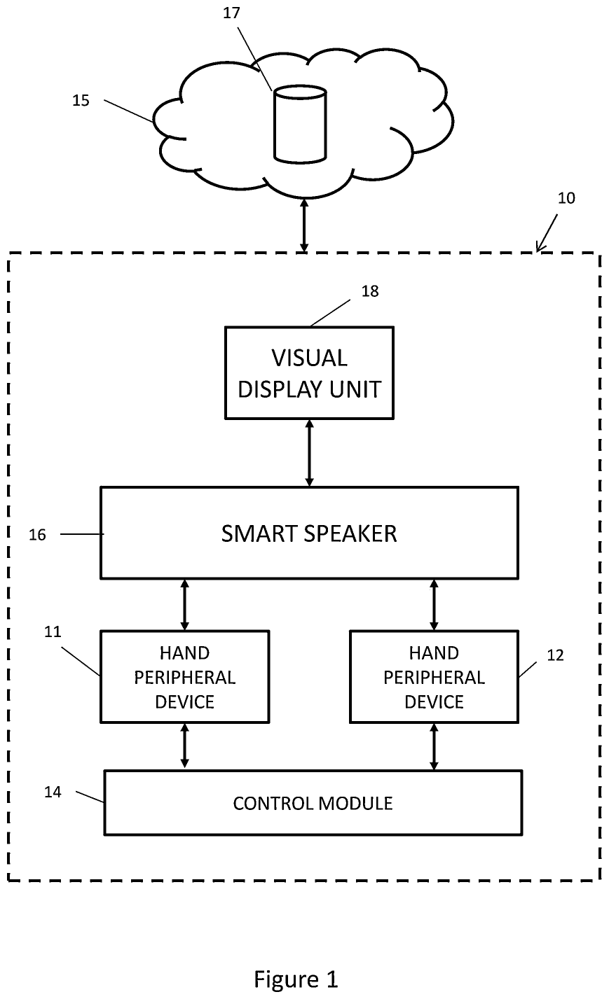

To place embodiments of the invention in a suitable context, reference will firstly be made to FIG. 1 which shows a schematic block diagram of a learning system 10 for teaching a student, for example a child, a new skill. The learning system 10 comprises a pair of hand peripheral devices 11, 12 that communicate with a smart speaker 16. When the smart speaker 16 receives and analyses data from the hand peripheral devices 11, 12 it may in return, initiate a response that is expressed in visual form and appears in the display 22 of the hand peripheral devices 11, 12 and a visual display unit 18, for example a screen, monitor or television.

As shown in FIG. 1 the visual display unit 18 is configured to generate a visual stimulus for the student. For example, the visual display unit 18 may display a learning exercise that the student should work on. Furthermore, the visual display unit 18 may also provide instructions to the student as to how the learning exercise should be completed.

The smart speaker 16 comprises a speaker for outputting audio to the student and a microphone for detecting words and sounds vocalised by the student. The smart speaker 16 is configured to generate audio stimuli for the student and furthermore, the microphone within the smart speaker 16 is configured to detect speech from the student.

The learning system 10 may be connected to a cloud computing network 15. The cloud computing network 15 may comprise a database 17 of learning content, that the learning system 10 may access to retrieve learning content from the cloud computing network 15. For example, the learning system 10 may retrieve, interactive television shows, games or learning exercises that a student may interact with using the learning system 10 and hand peripheral devices 11, 12.

The smart speaker 16 may communicate wirelessly with the cloud computing network 15 to select learning content from the database 17, and the difficulty level would be contingent upon the student's performance with the learning exercises.

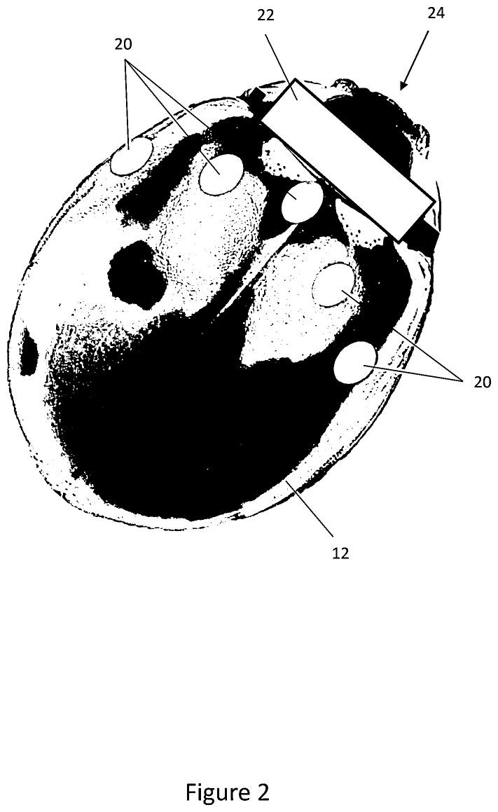

Turning now to FIG. 2 a schematic plan view of the right-hand peripheral device 12 is shown in further detail. The hand peripheral device 12 is an ergonomically designed peripheral device and comprises an array of five buttons 20, one for each finger, and a display 22. The array of buttons 20 are distributed along an arcuate path such that each button 20 is positioned ergonomically, to allow a student to rest their fingertips on a button 20 corresponding to that finger.

Each button 20 of the hand peripheral devices 11, 12 comprise an actuator configured to provide haptic feedback pulses to the button. The intensity of haptic feedback pulses may be manually adjusted by pressing a button integrated into the control module 14, or upon verbal request to the smart speaker 16. The control module 14 may incorporate other function buttons and may take on the form of a wrist rest.

The display 22 of the hand peripheral device is positioned at a distal end 24 of the peripheral devices 11, 12 and, is configured to display information to the student corresponding to each button 20 on the peripheral device 12. The display 22 extends laterally across the hand peripheral device 11, 12 and is positioned distally of the array of buttons 20 such that the display 22 may provide visual information to the student that corresponds to a button 20 in the array. The display 22 may provide a visual instruction stimulus to the student that corresponds to a specific button 20, within the array. For example, the display 22 may provide an arrow that points to the student's finger, and thus a specific button 20 within the array, that is about to receive haptic feedback. Furthermore, the display 22 may display the alphabet and the alphabet may be divided so that between one and three letters are assigned to each button 20 within the array. Alternatively, the display 22 may display the numbers 0 to 9 where each number corresponds to a button 20 within the array.

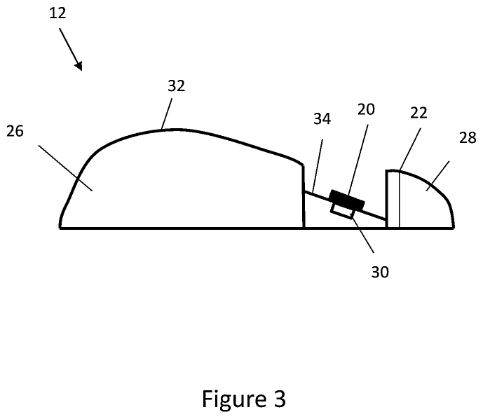

Turning now to FIG. 3 a schematic side view of the right-hand peripheral device 12 is shown. The peripheral device 12 comprises a body 26 and a head 28. The body 26 and the head 28 may be embellished so as to be synonymous with an insect, for example a ladybug. This may be beneficial for making young students engage with the learning system 10, as the bright colours of the hand peripheral devices 11, 12 may attract the attention of the student.

The body 26 of the peripheral device 12 has a curved or domed upper surface 32 such that the body 26 of the peripheral device 12, may fit ergonomically within the palm of a student's hand. The head 28 of the hand peripheral device 12 is moveable between a stored position and a deployed position (as shown in FIG. 3). When the head 28 is in the deployed position, the buttons 20 of the array are unveiled such that a student may rest their fingers on the buttons 20. The display 22 may be mounted on the head 28 of the peripheral device 11, 12 such that when the head 28 is in the deployed position, the display 22 is located distally of the array of buttons 20.

The head 28 of the peripheral device 12 is moveable from the stored position to the deployed position by, moving the head 28 in a distal direction away from the body 26. Moving the head 28 in a distal direction away from the body 26 unveils the array of buttons 20 such that the student may use the peripheral device 11, 12. Returning the head 28 to the stored position may be achieved by, sliding the head 28 towards the body 26 in a proximal direction. When the head 28 is in the stored position the array of buttons are received within the body 26 and the head 28 abuts the body 26.

The buttons 20 of the peripheral device 12 may be over the top surface of a ramped intermediate portion 34. The intermediate portion 34 is attached to a distal end of the body 26 and the head 28 may slide over the intermediate portion 34 between the stored and deployed positions. The array of buttons 20 may be positioned along an arcuate path. This is beneficial as when a student places their hand on the device 12 the student may rest the tips of their fingers on each of the buttons 20.

Each button 20 comprises a piezoelectric actuator 30 located beneath the button 20 within the intermediate portion 34 of the body 26. The piezoelectric actuator 30 may be controlled to transmit haptic feedback to the tips of the user's fingers.

In another embodiment, each button 20 may have an aperture. In this embodiment each hand peripheral device 11, 12 may comprise an ultrasound speaker located within the intermediate portion 34. The ultrasound speaker may project ultrasound waves through the respective apertures such that, the ultrasound waves are focused on and target the middle of the users' finger pads. The ultrasound speaker may be mounted on a pivot and swivel base within the intermediate portion 34. The pivot and swivel base beneficially allows the ultrasound speaker to be articulated, to target the ultrasound waves at the appropriate finger pad. The ultrasound speaker may beneficially convey pulses that may be felt by a user through their fingertips.

Furthermore, the head 28 of the peripheral devices 11, 12 may be configured to automatically retract, when the learning system 10 detects that the system has been inactive for a specified period. Automatically retracting the head 28 of each peripheral device 11, 12 would protect the buttons 20 and/or ultrasound speaker from damage if the peripheral devices 11, 12 are left unattended. To resume use of the learning system 10, a user may verbalise an instruction to the smart speaker 16 to move the head 28 from the stored position to the deployed position or, press a function button integrated into the control module 14.

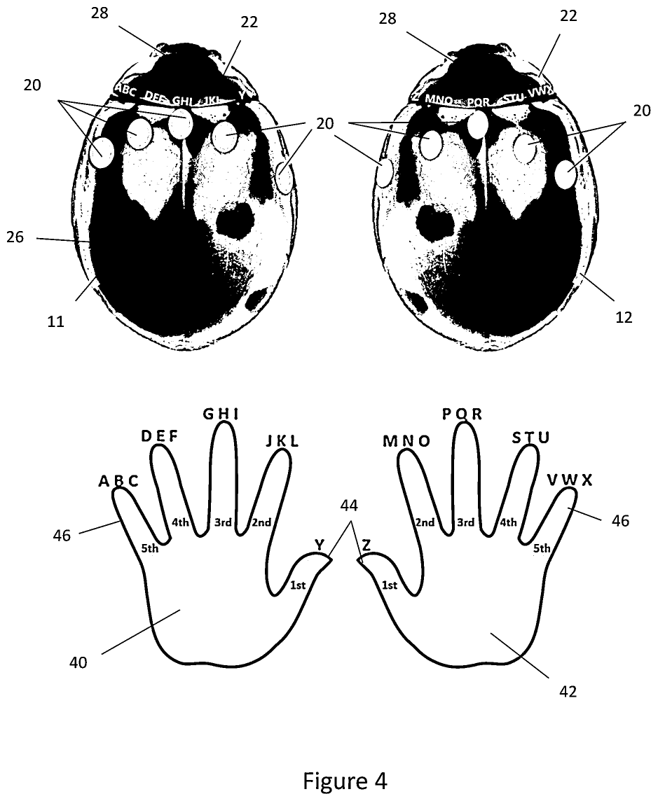

Turning now to FIG. 4, the left and right-hand peripheral devices 11, 12 of the learning system 10 are shown schematically above a student's hands 40, 42. The left-hand and right-hand peripheral devices 11, 12 form part of the learning system 10 and, when in use, would be positioned in front of the visual display unit 18 such that the student may rest their hands on the peripheral devices 11, 12 and view the visual display unit 18.

As shown in FIG. 4 each finger on the student's hands 40, 42 is attributed a number, starting at one with the student's thumbs 44 and increasing incrementally to five with the student's little finger 46. Each finger is attributed one or more letters of the alphabet that correspond to the letters shown on the display 22. Each of the one or more letters that are attributed to each finger also correspond to a button 20, within the array on the peripheral device 11, 12.

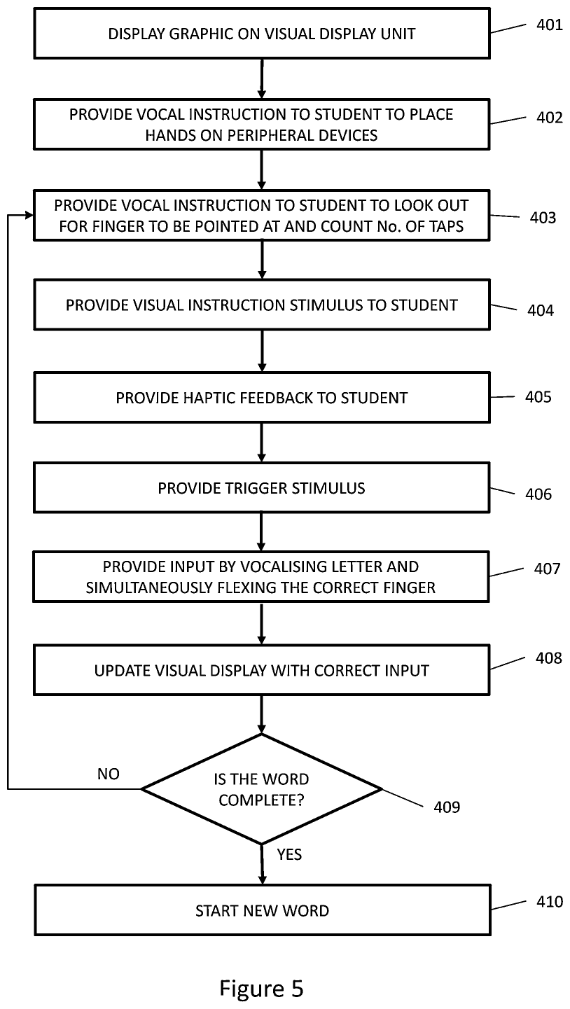

FIG. 5 shows a method of using the learning system 10 to teach a student to spell a new word. In Step 401 a graphic is displayed on the visual display unit 18 to illustrate the length of the new word that is to be spelt. The graphic may be displayed in the following segmented format, comprising dashes to represent missing letters and forward slashes to break the word up into segments. For example, the forward slashes may be positioned to segment the word into syllables. An example graphic may be in the following general format displayed in red to begin with but, switches to black at step 404:
_ _ _/_/_ _ _

In Step 402 the smart speaker 16 prompts the student with a vocal instruction to position their hands 40, 42 on the hand peripheral devices 11, 12. The student would then position their hands 40, 42 on the peripheral devices 11, 12 and, position their fingertips on each of the buttons 20 on the peripheral devices 11, 12. As mentioned above the buttons 20 may comprise piezoelectric actuators 30, and the buttons 20 or peripheral devices 11, 12 may be configured to detect, when a student has positioned their hands 40, 42 on the devices 11, 12 and their fingertips are resting on the array of buttons 20.

In Step 403 the smart speaker 16 is configured to provide another vocal instruction to the student. For example, the smart speaker 16 may say “Now look at the finger I point at and count how many times I tap it”. The student would then look at their hands 40, 42 that are resting on the hand peripheral devices 11, 12 and await a further stimulus.

In Step 404, the display 22 from the hand peripheral device 11, 12 may prompt the student with a visual instruction stimulus in the form of an amber arrow which points to the button 20, and thus finger, that the first letter in the word that is to be spelt corresponds to. For example, the display 22 may show an amber LED arrow that is illuminated for about 2 seconds and points in the direction of the fourth finger on the right-hand. An instruction stimulus at this position would indicate that the first letter in the word is one of S, T or U, see FIG. 4.

At this point the alphabet may not be shown on the display 22 but a student who practices extensively, may acquire the ability to recall from memory that an instruction stimulus pointing in the direction of the fourth finger on the right-hand, is indicating that the first letter of the word must be one of S, T or U.

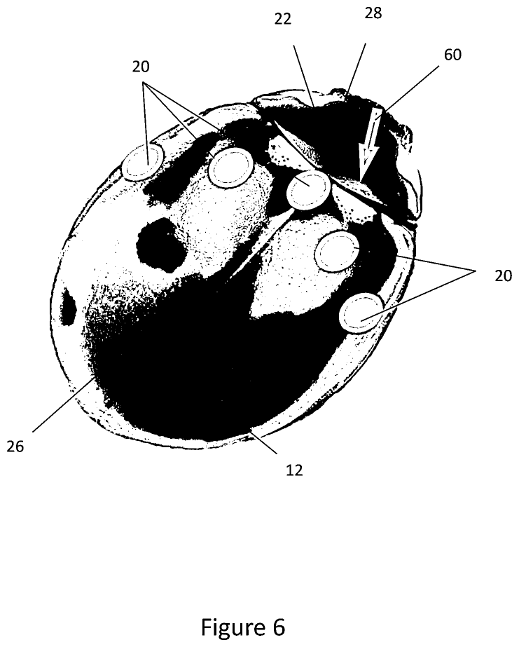

FIG. 6 shows a schematic example of the right-hand peripheral device 12 producing an instruction stimulus in the form of, an amber LED arrow 60 illuminated on the display 22. This instruction stimulus draws the gaze and attention of the student to a particular finger. If the student does not see the amber arrow 60 illuminated on the display 22, they may ask that the instruction stimulus is repeated by verbalising a request for that instruction stimulus to be repeated by the smart speaker 16. The smart speaker 16 may repeat the instruction stimulus and the amber arrow 60 may be reilluminated.

Returning now to FIG. 5, in Step 405 haptic feedback is transmitted to the students' finger through the button 20 that corresponds to, the finger that the instruction stimulus drew the student's attention to. The haptic feedback may be in the form of one or more pulses or vibrations each lasting about 0.5 seconds, delivered to the student by the actuator 30 and button 20. FIG. 6 illustrates haptic feedback is transmitted in the form of a single pulse at the location of the button 20, corresponding to the fourth finger on the right-hand 42 of the student. A single pulse provided to the button 20 corresponding to the fourth finger on the right-hand peripheral device 12 represents the letter “S” (see FIG. 4).

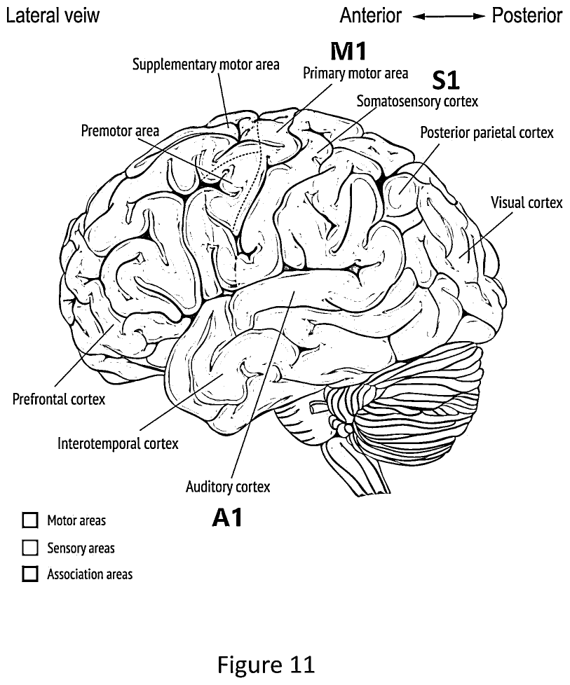

Prompting the student with an instruction stimulus that draws their attention and gaze to a particular finger that is about to receive haptic feedback is beneficial, as it reduces the level of beta rhythms in the region dedicated to the hand within the primary somatosensory cortex (S1) of the student's brain, see (S1) FIG. 11. Reducing beta rhythms within the student's brain heightens perception of haptic stimuli which in turn, has the potential to raise the probability of the student correctly deciphering the number of haptic feedback pulses into a letter. As such, in Step 404 and Step 405 the student is decoding the visual stimulus and haptic feedback to strategize their next action. With extensive practice, a student may be able to decode the letter that is to be entered from deciphering haptic feedback, before the alphabet is revealed on the display 22.

Following Step 405, the student should still have the number one held in their working memory where the number one is indicative of the number of haptic pulses provided to the student via the button 20. Furthermore, the student should still recall that the single haptic feedback pulse was transmitted to their fourth finger on their right-hand 42.

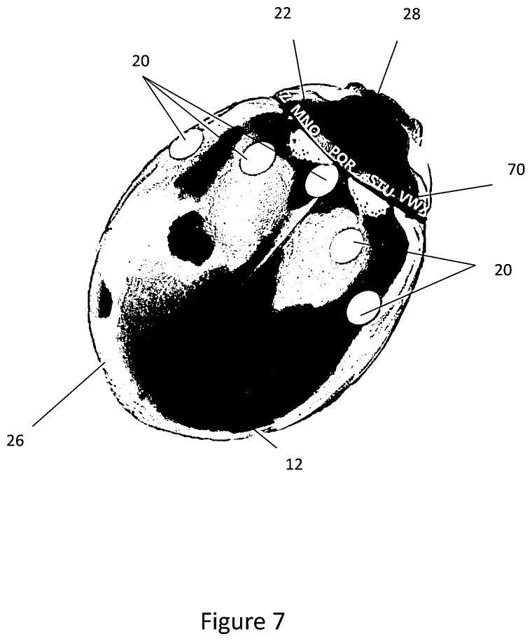

Next, in Step 406 the learning system 10 provides a trigger stimulus to the student. The trigger stimulus may be a visual and/or an audible stimulus provided to the student that indicates that, the student should provide an input via one or more of the buttons 20. In the example shown in FIG. 7, the trigger stimulus is in the form of an alphabet 70 illuminated in green shown on the display 22. As shown in FIG. 7, the alphabet 70 on the display 22 is grouped such that three letters correspond to each button 20 associated with a finger, and a single letter is positioned to correspond with the button 20 associated with the thumb 44 of the student.

When the alphabet 70 is revealed on the display 22 the smart speaker 16 may simultaneously provide an audible cue which may form part of the trigger stimulus. For example, the smart speaker 16 may provide an audible instruction by saying “go” to the student. When prompted by this audible cue, the alphabet on the display 22 appears at the same time, and the student should deduce from seeing the letters assigned to the fourth finger on their right-hand 42, that one haptic feedback pulse represented the first letter in the series out of the possible three.

In Step 407, to fill the empty dash on the visual display unit 18 with the letter “S” the student must proceed to flex their fourth finger on their right-hand 42, so as to push the button 20. Furthermore, as they flex their finger to push the button 20 the student must also simultaneously vocalise the letter “S”.

To successfully input letters into the learning system 10, the student must both vocalise a letter as and when the corresponding finger is flexed to push the correct button 20. By simultaneously vocalising a letter and pushing the correct button 20, the student is activating their brain's auditory cortex (A1) in conjunction with the primary motor cortex (M1), refer to FIG. 11. Activating both the auditory cortex (A1) and the motor cortex (M1) is beneficial, as it helps the student to activate their procedural memory thereby allowing them to quickly and correctly spell words they learn using the learning system 10. As such, learning becomes a multi-sensory experience and, memories become more multifaceted, which may provide alternative pathways for a memory or particular facet(s) of a memory, to be retrieved.

In Step 408, if the smart speaker 16 detects a single input from the fourth button 20 on the right-hand peripheral device 12, and also a correct verbal input then the smart speaker 16 will fill in the first dash on the screen of the visual display unit 18, with the letter “S” as shown below:
S_ _/_/_ _ _

If the smart speaker 16 does not detect both a verbal input from the student and an input from the button 20 then, the smart speaker 16 may advise the student that they must both verbalise the letter and input the letter via the hand peripheral device 11, 12. Similarly, if the student provides a wrong input either verbally or via the hand peripheral device 11, 12 then the smart speaker 16 may ask them to repeat Step 407.

In Step 409 the smart speaker 16 may check if the word is complete. If the word is not yet completely spelt, then the learning system 10 may return to Step 403 during which the dashes on the visual display unit 18 appear in red, and turn black at step 404 where a new instruction stimulus (amber arrow) is provided to the student. For example, the smart speaker 16 may say “Now look at the finger I point at and count how many times I tap it.” An amber arrow 60 pointing at a different finger may be revealed on the display 22, to draw the attention and gaze of the student to the finger that is about to receive a haptic pulse(s).

In the current example, in Step 404 the amber arrow 60 on the display 22 may now point to the first finger the thumb 44, of the student's left-hand 40 which, as shown in FIG. 4, corresponds to the letter Y. The arrow 60 may be displayed for about 2 seconds and when that arrow 60 is removed from the display 22, a single haptic feedback pulse may be provided to the students' left-hand thumb 44, via the corresponding button 20 on the left-hand peripheral device 11, to provide haptic feedback to the student in accordance with Step 405.

Next, in Step 406 a trigger stimulus is again provided to the student. As outlined above the student should still have the number one in their mind, corresponding to the number of haptic pulses transmitted to the students' thumb. However, this time the student should associate the number one with the first finger 44 on their left-hand 40. When the trigger stimulus is provided, and the alphabet 70 is illuminated in green, the student will see that the first button on the left-hand peripheral device 11 corresponds to the letter “Y”. In Step 407 the student will press the button 20 corresponding to the first finger 44 on the left-hand peripheral device 11 once, whilst simultaneously vocalising the letter “Y”.

In Step 408 the smart speaker 16 will again compare the received input from the hand peripheral device 11, and the smart speaker microphone 16. If the student pressed the button 20 that corresponded with the correct letter whilst simultaneously vocalising the correct letter, then the visual display unit 18 is updated. In the example shown the letter “Y” is added to the visual display unit 18 as follows:
SY_/_/_ _ _

In Step 409 the smart speaker 16 will determine that the word is still not complete and as such would return to Step 403. The process of deciphering haptic feedback and then flexing fingers whilst simultaneously vocalising the letter may continue until the word SYNAPSE is correctly spelt. In the example shown this process would continue a further five times until the entire word had been spelt out as follows:
S Y N/A/P S E

When the word has been correctly spelt by the student the learning system 10 may progress to Step 410 and a new word may be spelt by the student.

Upon correct completion of the spelling the smart speaker 16 of the learning system 10 would give praise and demonstrate how the word is correctly pronounced, (including possible alternative pronunciations), then request the student to repeat after ‘her’ or ‘him’ once it has said the word. The smart speaker 16 would then monitor for their attempt and lastly provide the definition of the word to the student. The smart speaker 16 may then offer to present on the screen of the visual display unit 18 and read aloud example sentences, that incorporate the word including animations where possible.

Humans possess an innate ability to hone their sensory systems; known as perceptual learning. Repeated exposure to tactile stimuli during the games or spelling procedure, may hone one's sense of touch. Recall that Step 404 comprises an instruction stimulus in the form of an amber LED arrow 60 on the display 22, to direct one's attention to the finger about to receive a haptic pulse(s), to reduce beta rhythms in the primary somatosensory cortex (S1), with the intended aim of raising perception of haptic feedback.

In consideration of the inherent potential for tactile perceptual learning (honing one's sense of touch), the instruction stimulus (amber LED) could eventually be deemed superfluous, therefore, the method and learning system 10 may be configured by the student to deactivate this feature and omit the preceding vocal instruction in Step 403, followed by the amber arrow in Step 404 if a faster pace of game playing is desired.

With considerable practice one could expect the student to commit to memory the assignment of the alphabet to their fingers as illustrated in FIG. 4. In view of this, the learning system 10 and method may be adapted so as to receive haptic feedback pulses for an entire segment of a word, for example SYN, then flexing the appropriate fingers the correct number of times whilst simultaneously vocalising the letters to spell out that segment. Once the student becomes accustomed to the learning system 10 or if they have a strong working memory, then they may be able to spell out entire words without the need for segmentation and simply decipher haptic feedback, to flex their fingers to press the correct buttons whilst, simultaneously vocalising the correct letters to spell the entire word.

The default interstimulus interval (ISI) or simply put, the pause between each haptic feedback pulse should be set to one second. However, the ISI may be adjusted accordingly by pressing a function button integrated into the control module 14, or upon verbal request to the smart speaker 16.

As shown in the example above, spelling the word SYNAPSE using the learning system 10 the word is divided into three separate segments, namely: SYN/A/PSE. Dividing words into segments may assist the brain at memorising how to spell a word. As such, the learning system 10 and associated method may be adapted such that students new to this method of spelling have to repeat the process of deciphering each segment of a word twice. This may be beneficial as it could promote the development of new neural pathways within the student's brain through repeated patterns of motor movement, (flexing digits and simultaneously speaking) that become etched into procedural memory. Ultimately, the formation of new neural pathways from repeated patterns of motor movement that are unique to each word spelt, may culminate in the student developing the procedural memory ability that enables them to spell words without the need for hand peripheral devices and haptic feedback, but rather from flexing their digits (fingers) whilst vocalising letters.

This approach of segmenting words that the student is to spell is intended to afford the brain adequate time to process the information, decipher pulses and hold it in working memory, as opposed to attempting to commit to memory the entire sequence of letters in one fell swoop. This may prove beneficial when a student is learning how to spell new words or long words that they are unacquainted with and, to overcome problems that arise from working memory limitations/deficits.

In the example outlined above the visual display unit 18 is described as showing a series of dashes to be populated by letters that, may be input into the learning system 10 by a student as they spell the word. However, the learning system 10 may also display via the visual display unit 18 illustrations that are indicative of the word to be spelt, thereby further stimulating the visual and auditory cortex as one replays the sound of the word in their mind. An image may hint at how a word is spelt by thinking about the phonetics and may also trigger the students' memory into recalling the definition, along with a partial or complete spelling of the word. It might also assist with developing the ability to identify letters of the alphabet, in the form of tactile pulses.

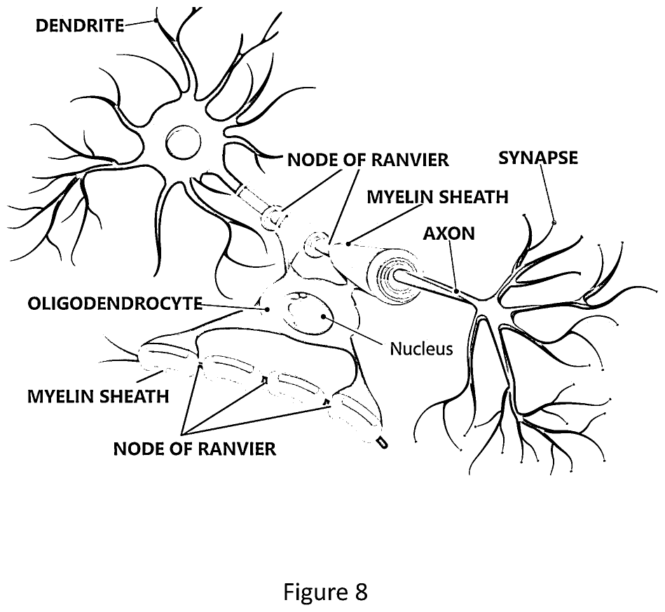

FIG. 8 illustrates a cell called an OLIGODENDROCYTE, attracted by the heightened activity through specific pathways and has attached itself to the AXON of two neurons to produce a MYELIN SHEATH. The aforementioned method of learning to spell new words using the learning system 10 is intended to activate specific pathways within the students' brain. With spelling practice the heightened activity within these pathways may promote a transformation of a neurons' axon through a process of myelination, to produce a myelin sheath that encapsulates the axon, known as white matter.

Myelin appears as a white waxy coating that encapsulates axons. It acts as an insulator that supports faster transmission of electrical signals (impulses) between neurons. In the case of a non-myelinated axon, the electrical signals must run the course of the axon. By comparison, electrical signals can move along a myelinated axon up to 100 times faster, by jumping from node to node as illustrated, see NODES OF RANVIER in FIG. 8.

Whilst the example outlined above is in relation to teaching a student how to spell a new word, the learning system 10 may be used to teach students other skills. For example, the learning system 10 may be used to teach a student to learn a new language or to improve their numeracy skills. Furthermore, the learning system 10 may be used by stroke patient's to hone their fine motor skills and to relearn skills they may have lost as a result of the stroke.

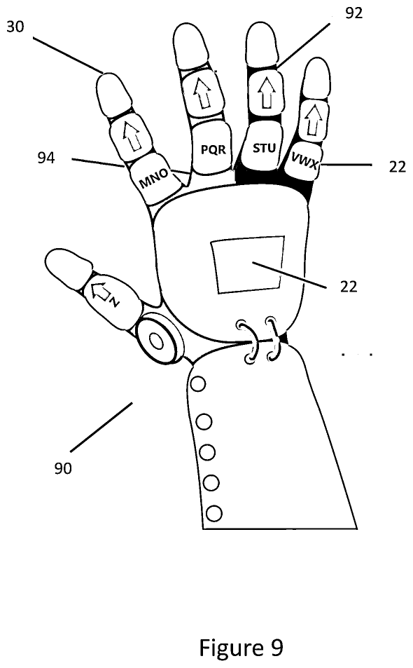

Furthermore, it is envisaged that the hand peripheral devices 11, 12 may be replaced with wearable gloves. FIG. 9 shows a schematic representation of a glove 90 for use with embodiments of the invention. A glove 90 may be worn on each hand of a student or, for example, a contestant on a television show. The gloves 90 comprise similar features to that of the hand peripheral devices 11, 12. For example, the student would wear a glove 90 on each of their hands 40, 42 and the glove 90 would comprise a display 22 for displaying the alphabet 70 to the student. Each glove 90 may comprise two displays 22. For example, a first, primary display may be positioned on the back of the user's hand may show the letter that will populate the dash. Furthermore, smaller secondary displays 22 may be located on each finger to show the letters of the alphabet that correspond to each finger. Furthermore, each finger display may additionally display an amber arrow to provide an instruction stimulus to the user.

The gloves 90 may further comprise mild resistance in the form of a spring back mechanism 92 or the like to support the extension phase of the finger movement. The spring back mechanism 92 would provide resistance when the student flexes their finger and thus, impel their finger back to the extended position following the flexion phase of movement.

Furthermore, the gloves 90 may comprise actuators 30 positioned at each fingertip of the glove 90, such that the actuators 30 may provide haptic feedback as outlined above to the fingertips of the student.

The gloves 90 further comprise a series of sensors 94 to detect which digit is flexed the furthest by the student, so as to reduce false positive readings associated with inadvertent movement of other fingers when the intended finger is flexed. For example, if a student were to flex their third finger fully they would also inadvertently flex their fourth finger simultaneously. As such, the sensor 94 within the glove 90 may measure the arc length travelled by the fingertip of the student. Measuring the arc length travelled by the fingertip of the user may beneficially, reduce false positive readings associated with inadvertent flexing of fingers.

The sensors 94 may replace the buttons 20 on the hand peripheral devices 11, 12 such that, to input a letter the student may flex a finger within the glove 90 following haptic feedback transmission. As the student flexes their finger within the glove 90 they should simultaneously vocalise the relevant letter.

It is envisaged that the gloves 90 may be used by contestants on TV shows and by students viewing the TV shows. For example, the student may use the learning content to stream the TV show from the database 17 on the cloud computing network 15. The student may then use either gloves 90 as described above or hand peripheral devices 11, 12 to watch the TV show on the visual display unit 18, and to interact with the TV show.

The contestant on the TV show would beneficially wear the gloves 90 such that the student viewing the TV show content, may visually watch the contestant flexing their fingers thereby receiving a further visual stimulus from the visual display unit 18 showing the TV show.

Up until now the visual display unit 18 has been described as a screen or monitor. However, the visual display unit 18 may take on the form of a Virtual Reality (VR) headset, an Augmented Reality (AR) headset or the like that a student could wear. Furthermore, the VR/AR headset could be combined with wearable gloves as outlined above. The learning system 10 may then be used for more complex tasks than learning new words to spell.

If we take the example of medical students who need to learn the anatomical names; locations; functions of the different muscles, bones, and organs of the body. The learning system 10 may be used to develop procedural memory that enables one to, improve semantic memory for facts quicker but, could be further supplemented by hand gestures made with the gloves that manipulate the angle and perspective, of an AR or VR representation of different parts of the anatomy. When performed repetitively, these hand gestures (kinaesthetic movements) could contribute to the development of, procedural memory that enables the student to, form and retrieve memories of the anatomy more easily and in richer detail and, could be applied in a doctor-patient appointment to aid explanations.

Haptic feedback to the fingertips from the glove peripherals may also enhance declarative memory development. For instance, if a medical student wanted to focus on a specific region of the human anatomy in AR or VR such as, the bones of the hand, haptic pulses to the fingertips could be used to represent bony prominences and would be felt when, manoeuvring the hand and fingertips over the AR/VR simulated structure.

Med students learn a multitude of medical abbreviations, acronyms and mnemonics that represent parts of the anatomy, medical conditions, and procedures. The learning system 10 may receive learning content from the database 17 that could, for example, involve palpating an AR simulation of an anatomical region, and to learn and associate unique tactile messages that represent an acronym or mnemonic, then to spell out in full what the acronym or mnemonic is by flexion and extension of the digits whilst vocalising.

Scrub nurses play an integral role in the operating theatre. Over the course of their career, they are required to identify numerous pieces of surgical instruments and, anticipate when they will be needed. Augmented reality combined with the learning system 10 could enhance their ability to memorise and spell, various surgical instruments and recall what phase of an operation the tool would be required.

It will be appreciated that various changes and modifications can be made to the present invention without departing from the scope of the present application.

1. A method of teaching a student a skill using a learning system, the learning system comprising a smart speaker equipped with a microphone for listening to vocal responses and instructions issued by the student; a pair of hand peripheral devices each having an array of actuators corresponding to each of the student's fingers wherein the actuators are configured to provide one or more haptic feedback pulses to the student, the method comprising:
providing a vocal instruction that prompts the student to look at their hands and to wait for a haptic feedback pulse;
providing a visual instruction stimulus to the student, wherein the visual instruction stimulus corresponds to one of the student's fingers;
providing the one or more haptic feedback pulses to said finger; and
providing a trigger stimulus to the student to notify the student that a response should be input to the learning system;
wherein inputting the response to the learning system comprises simultaneously vocalising a letter and flexing the finger that received the haptic feedback pulse.

2. A method as claimed in claim 1, wherein flexing the finger that received the haptic feedback pulse comprises depressing the actuator corresponding to said finger.

3. A method as claimed in claim 1, wherein providing the visual instruction stimulus comprises drawing the student's attention to the finger before said finger is provided with the haptic feedback pulse.

4. A method as claimed in claim 1, wherein the method comprises, upon the received visual instruction stimulus and haptic feedback pulse, determining a letter that is to be input as the response.

5. A method as claimed in claim 1, wherein providing the trigger stimulus comprises displaying an alphabet on a display.

6. A method as claimed in claim 1, wherein providing the trigger stimulus comprises providing an audible cue to the student.

7. A method as claimed in claim 1, wherein inputting the response causes the letter to be displayed on a visual display unit.

8. A method as claimed in claim 7, comprising comparing the vocalised letter with a correct letter for spelling a word and displaying the letter on the display when it is determined that the vocalised letter matches the correct letter.

9. A method as claimed in claim 7, wherein displaying the letter on the visual display unit comprises displaying the letter within a segmented word that the student is learning to spell.

10. A method as claimed in claim 9, wherein segmentation of the segmented word is dependent on the student's spelling ability.

11. A method as claimed in claim 8, wherein the method comprises displaying illustrations to the student wherein the illustrations are indicative of the word.

12. A method as claimed in claim 1, comprising varying the number of haptic feedback pulses provided, depending on the letter to be vocalised and finger to be flexed.

13. A learning system for teaching a student a learning outcome, the learning system comprising:
a pair of hand peripheral devices each having an array of actuators corresponding to each of the student's fingers wherein each actuator is configured to provide a haptic feedback pulse to a corresponding finger wherein the haptic feedback pulse is indicative of the learning outcome;
a microphone configured to detect speech indicative of the learning outcome vocalised by the student; and
a control module connected to the pair of hand peripheral devices;
wherein the control module is configured to output a signal to the actuators to provide haptic feedback pulses to the corresponding finger; and
the control module is further configured to determine that the learning outcome has been satisfied in dependence on the student simultaneously pressing the actuator that provided the haptic feedback pulse and vocalising the learning outcome.

14. A learning system as claimed in claim 13, wherein the hand peripheral devices each comprise a display for displaying information to the student.

15. A learning system as claimed in claim 14, wherein the control module is configured to activate the display to display a visual instruction stimulus to the student prior to providing the haptic feedback pulse.

16. A learning system as claimed in claim 15, wherein the control module is configured to activate the display such that the visual instruction stimulus is displayed on the display at a position that corresponds to the finger that will receive the haptic feedback pulse.

17. A learning system as claimed in claim 14, wherein the control module is further configured to activate the display to display a trigger stimulus to the student after providing the haptic feedback pulse.

18. (canceled)

19. A learning system as claimed in claim 13, comprising a speaker for outputting a vocal instruction to prompt the student to look at their hands and wherein the control module is configured to cause the speaker to output the vocal instruction prior to providing haptic feedback to the corresponding finger.

20. A learning system as claimed in claim 19, wherein the hand peripheral devices each comprise a display for displaying information to the student; wherein the control module is further configured to activate the display to display a trigger stimulus to the student after providing the haptic feedback pulse; and wherein the trigger stimulus further comprises a verbal cue output from the speaker.

21. A learning system as claimed in claim 13, comprising a visual display unit and wherein the visual display unit is configured to display the learning outcome to the student when the control module determines that the learning outcome has been satisfied.

22. (canceled)
